(19) United States
(12) Patent Application Publication
(10) Pub. No.: US 2015/0327563 A1
(43) Pub. Date: Nov. 19, 2015

(54) Milk Powders Having Improved Sensory Properties

(71) Applicant: DMK Deutsches Milchkontor GmbH, Zeven (DE)

(72) Inventor: Martin Diekhaus, Holdorf (DE)

(21) Appl. No.: 14/714,783

(22) Filed: May 18, 2015

(30) Foreign Application Priority Data
May 19, 2014 (EP) EP 14 168 880.4

(51) Int. Cl. A23C 1/14; A23G 1/46; A23C 1/12; A23C 9/18

(52) U.S. Cl. CPC A23C 1/14; A23C 9/18; A23G 1/46; A23C 1/12; A23V 2002/00

(57) ABSTRACT

Milk powders having improved sensory properties are proposed which are obtainable in that
(a) a mixture is produced from a milk product and sugar,
(b) the mixture is subjected to a first temperature treatment and in the course of this is simultaneously sterilized and concentrated,
(c) the concentrate thus obtained is subjected to a second temperature treatment in which caramelization occurs,
(d) the caramelized product thus obtained is subjected to a first cooling,
(e) the first cooled product thus obtained is seeded with carbohydrate crystals,
(f) the seeded product thus obtained is subjected to a second cooling,
(g) the second cooled product thus obtained is subjected to a drying on a vacuum-belt dryer with subsequent comminution and finally
(h) the dry powder is discharged.

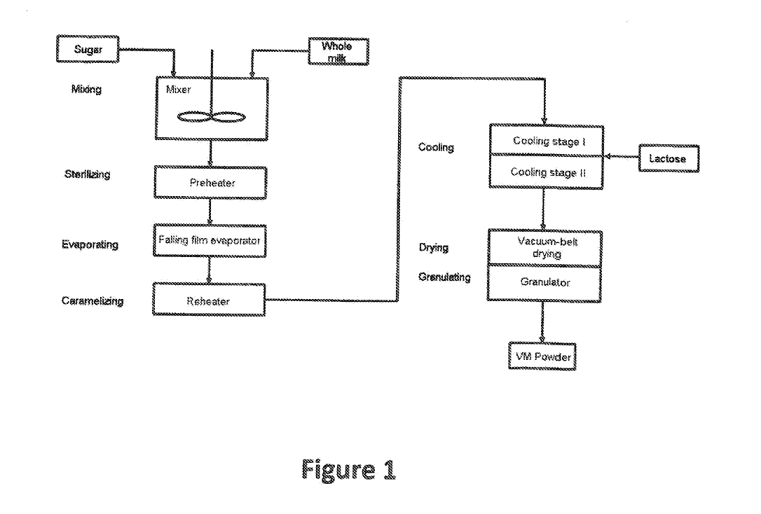

### FIELD OF THE INVENTION

The invention is in the field of milk products and relates to whole milk powders having improved sensory properties, a process for production thereof, and also the use of the powders.

### PRIOR ART

Production of whole milk powders usually perceives from whole milk which is concentrated in a first step in evaporators, before the remaining water fraction is then separated off by spray drying or roller drying. The powders typically contain about 26% by weight lipids, about 25% by weight proteins and about 38% by weight lactose. Milk powder serves, inter alia, for production of milk drinks, but also as base material for many baked goods and chocolate products. As concerns drink production, particularly, those powders are preferred which are of good solubility.

For instance, European patent application EP 2679098 A1 (DMK) discloses a process for producing low-microbe milk powders having a whey protein index (WPI) of at least 2, in which (a) raw milk is freed from solids in a manner known per se, the cream is separated off, (b) the resultant skimmed milk is subjected to a microfiltration, (c) the resultant permeate is pasteurized, the resultant pasteurized permeate is concentrated to a dry matter content of 30 to 50% by weight and the retentate is discarded, (d) the resultant concentrate is subjected to a temperature treatment at least 72° C. over a period of at least 15 seconds, and (e) the resultant temperature-treated product is processed to form a dry powder.

CN 2011 1116530 A1 discloses a process in which skimmed milk is sterilized at 72 to 78° C., and then concentrated in a vacuum at 45 to 75° C. in a falling film evaporator. The product is then dewatered by spray drying at 180 to 200° C. and processed to form a dry powder.

It is disadvantageous that current drying processes deliver powder mixtures having a particle size distribution such that size fractions which are desired or preferred from the application aspect must be laboriously screened out and oversize and undersize particles must be returned back to the process.

It is likewise disadvantageous that the powders of the prior art, owing to an unfavourable particle size distribution, are frequently not defective-free in sensory terms, and in particular have a sandy taste. These products are only marketable with restrictions, since the false taste note must always be individually masked or compensated for by adding flavourings.

The object of the present invention was thus to provide whole milk powders which are free from the disadvantages described at the outset. In particular, powders should be obtained directly without complex screening processes, which powders have a particle distribution which is so advantageous that they are simultaneously readily water-soluble and are free from taste defects.

### DESCRIPTION OF THE INVENTION

The invention relates to solid whole milk powders having improved sensory properties, which are obtainable in that
(a) a mixture is produced from a milk product and sugar,
(b) the mixture is subjected to a first temperature treatment and in the course of this is simultaneously sterilized and concentrated,
(c) the concentrate thus obtained is subjected to a second temperature treatment in which caramelization occurs,
(d) the caramelized product thus obtained is subjected to a first cooling,
(e) the first cooled product thus obtained is seeded with carbohydrate crystals,
(f) the seeded product thus obtained is subjected to a second cooling,
(g) the second cooled product thus obtained is subjected to a drying on a vacuum-belt dryer with subsequent comminution and finally
(h) the dry powder is discharged.

Milk products which come into consideration here are, for example, skimmed milk, whey, cream and, in particular, whole milk.

The invention further relates to a process for producing whole milk powders having improved sensory properties, in which
(a) a mixture is produced from whole milk and sugar,
(b) the mixture is subjected to a first temperature treatment and in the course of this is simultaneously sterilized and concentrated,
(c) the concentrate thus obtained is subjected to a second temperature treatment in which caramelization occurs,
(d) the caramelized product thus obtained is subjected to a first cooling,
(e) the first cooled product thus obtained is seeded with carbohydrate crystals,
(f) the seeded product thus obtained is subjected to a second cooling,
(g) the second cooled product thus obtained is subjected to a drying on a vacuum-belt dryer with subsequent comminution and finally
(h) the dry powder is discharged.

The process according to the invention utilizes, as milk products, for example skimmed milk, whey, cream and, in particular whole milk.

Surprisingly, it was found that the combination of the individual process steps, in particular the particular cooling, followed by the vacuum-belt drying, leads to whole milk powders which, without further measures, have a very advantageous particle size distribution. The powders are, in particular, readily soluble and free from sensory faults.

### BRIEF DESCRIPTION OF THE DRAWING

The present invention will be described in greater detail with reference to the accompanying drawing which illustrates a flowchart or flow diagram for carrying out the process according to the invention.

### DESCRIPTION OF THE PREFERRED EMBODIMENTS

Sterilization and Concentration

In the first section of the process, a highly sugared whole milk is sterilized and evaporated. In this case, whole milk and sugar are mixed in an agitator device, preferably in the weight ratio of about 40:60 to about 60:40, and in particular about 50:50, in such a manner that a preparation is formed which has a dry matter content of about 25 to about 40% by weight, and in particular of about 30 to about 35% by weight.

The sugared whole milk is subjected to a first temperature treatment which serves to sterilize the product. Usually, for this purpose, in a preheater, temperatures of about 100 to about 150° C., and in particular of about 110 to about 140° C., are applied.

The sterilized product is fed into an evaporator, preferably a falling film evaporator, in which it is dewatered under mild conditions with application of a temperature gradient of about 100 to about 50° C., and in particular about 95 to about 55° C., in such a manner that a sugared condensed milk is produced having a dry matter content of about 65 to about 90% by weight and preferably about 70 to about 80% by weight.

Caramelization

The resultant concentrate is transferred to a reheater, in which it is caramelized. For this purpose, it is allowed to stand in the oven at temperatures of about 85 to about 95° C., for a period of about 15 to about 30 minutes.

Cooling

The caramelization is followed by cooling. This process step is critical, since it is of importance that particles are generated here that have a narrow size distribution and on average (D90) have a diameter of less than 15 μm. Such precursors are jointly critical for the formable end products having the desired solubility and sensory properties. In order to ensure this, the product is first cooled in a first step to about 30 to about 40° C. The solution is oversugared at this point, i.e. sugars would start to separate out which would lead to uncontrolled agglomeration and growth of the particles. Therefore, the solution is seeded with carbohydrate crystals which again shift the solution equilibrium.

Carbohydrates which come into consideration here are primarily lactose, glucose and maltose. The usage rate is about 150 to about 250, and preferably about 200 g per 1000 kg of concentrate, equivalent to about 0.2% by weight. Subsequently the solution for example when lactose seed crystals are used—is cooled in the second step to 20 to 25° C., and is then ready to be dried.

In principle it is also possible to carry out the cooling in one step, provided that a sufficient amount of seed crystals is added. This is the case, for instance when glucose is used. When especially lactose is used, in contrast the two-stage process has proved to be more advantageous with respect to inhibition of crystallization.

Vacuum-Belt Drying

Vacuum-belt dryers consist substantially of a housing having built-in, product-transporting conveyor belts which are drawn over heating units. An automatic belt controller ensures precise belt running. The belts are run in parallel in one or more planes and a metering pump having an oscillating nozzle is assigned to each of the belts, which nozzle applies the product according to the invention as foam. The applicant has found that precisely this manner of metering leads to products ultimately being obtained which, in comparison with those, for example, from spray drying, are markedly superior with respect to particle size distribution and therefore solubility and sensory properties. In addition, there is a boiling point shift in the vacuum, which ensures that the evaporation temperature falls and the product can be dried more gently. The principle has been known for as long as since the middle of the 1950s (cf. DE 948678 A, BAYER).

The highly sugared milk products pass during the drying through a high viscous, frequently also sticky, phase, whereby, owing to steam bubble formation in the product at the end of the drying course, a dry cake forms on the belt. Whereas the belts first run over a plurality of heating zones that are adjustable independently of one another, the last zone is a cooling zone in which the dry cake cools to brittle fragility, is broken up with a guillotine and is comminuted in the crusher or granulator.

The vacuum-belt dryer can be heated with steam, pressurized water or thermal oil, the vacuum is generally generated by a combination of steam jet pump with downstream condenser and water ring vacuum pump. In the heating zones the temperature there is usually about 60 to about 90° C. and in particular about 70 to about 80° C., wherein the pressure is generally at about 0.1 to about 0.9 bar and in particular about 0.2 to 0.8 bar. The heating zones, as already mentioned, are individually controllable, in such a manner that it is possible to apply any desired temperature profile. In the cooling zone, then temperatures of about 20 to about 25° C. prevail. In principle, it is necessary to carry out the drying at the lowest possible temperatures in order to minimize the formation of insoluble particles. A structural alternative would be, for example, also a vacuum drying cabinet.

The present invention further relates to the use of a vacuum-belt dryer for producing milk powders.

### INDUSTRIAL APPLICABILITY

The invention further relates to the use of the milk powders according to the invention, and the products obtainable by the process according to the invention, firstly for producing milk drinks, and secondly for producing chocolate products.

In the latter case, one of the heating zones of the vacuum-belt dryer can be controlled to be so high that here additional caramelization of the product occurs. In this manner, although the particle size distribution is shifted a little in the direction of the coarser fractions, which impairs the solubility slightly, the taste quality of the products is markedly improved for the planned use.

### EXAMPLES

### Example 1

A sugared whole milk having a sugar fraction of 51% by weight and a dry matter content of 33% by weight was sterilized in a preheater at 145° C. and then evaporated to a dry matter content of 75% by weight in a falling film evaporator with application of a temperature gradient from 95 to 55° C. The product was caramelized in a reheater for 25 minutes at 90° C. and then cooled to 30° C. The solution was admixed with 0.2% by weight crystalline lactose, stirred intensively and then cooled to 20° C. The cooled mass was foamed via a feed pump and an oscillating nozzle onto the conveyor belt of a vacuum-belt dryer. This had three heating zones (80, 70 and 50° C.) and one cooling zone (25° C.) (pressure: 0.5 bar). The dry cake was comminuted and the solubility of the powder in water (g/litre) and also the sensory properties (sandy taste: 3=pronounced, 2=present, 1=not observable) were assessed by a panel consisting of three experienced testers.

### Comparative Example V1

Example 1 was repeated, but the caramelized product was cooled to 25° C. in one step without addition of seed crystals.

### Comparative Example V2

Example 1 was repeated, but the drying was carried out in a spray dryer at a temperature of 180° C.

### Comparative Example V3

Example 1 was repeated, but the drying was carried out on a drying roller at a temperature of 140° C.

The results are summarized in Table 1. They show that only the products obtainable by the process according to the invention correspond to the requirements with respect to solubility and sensory quality.

TABLE 1
Solubility and sensory quality

| | Solubility | Sensory quality |
|---|---|---|
| Examples | index (ml) | (mean value) |
| 1 | <0.1 | 1 |
| V1 | <0.2 | 2 |
| V2 | 2.0 | 3 |
| V3 | 6.0 | 3 |

1. A milk powder having improved sensory properties, obtainable in that
(a) a mixture is produced from a milk product and sugar,
(b) the mixture of step (a) is subjected to a first temperature treatment and in the course of this is simultaneously sterilized and concentrated,
(c) the concentrate of step (b) is subjected to a second temperature treatment in which caramelization occurs,
(d) the caramelized product of step (c) is subjected to a first cooling,
(e) the first cooled product of step (d) is seeded with carbohydrate crystals,
(f) the seeded product of step (e) is subjected to a second cooling,
(g) the second cooled product of step (f) is subjected to a drying on a vacuum-belt dryer with subsequent comminution, and finally
(h) the dry powder of step (g) is discharged.

2. The powder of claim 1, wherein the milk product is whole milk, skimmed milk, whey or cream.

3. A process for producing milk powders having improved sensory properties, comprising the following steps:
(a) producing a mixture from a milk product and sugar,
(b) subjecting the mixture obtained in step (a) to a first temperature treatment and in the course of this is simultaneously sterilized and concentrated,
(c) subjecting the concentrate obtained in step (b) to a second temperature treatment in which caramelization occurs,
(d) subjecting the caramelized product obtained in step (c) to a first cooling,
(e) seeding the first cooled product obtained in step (d) with carbohydrate crystals,
(f) subjecting the seeded product obtained in step (e) to a second cooling,
(g) subjecting the second cooled product obtained in step (f) to a drying en a vacuum-belt dryer with subsequent comminution, and finally
(h) discharging the dry powder obtained in step (g).

4. The process of claim 3, wherein the milk product used is whole milk, skimmed milk, whey or cream.

5. The process of claim 3, wherein a mixture is used in step (a) containing the milk product and sugar in the weight ratio of about 40:60 to 60:40.

6. The process of claim 3, wherein a mixture is used in step (a) having a dry matter content of about 5 to about 40% by weight.

7. The process of claim 3, wherein the first temperature treatment in step (b) is carried out in two stages first at a temperature in the range from about 100 to about 150° C. and then with application of a temperature gradient from about 100 to about 50° C.

8. The process of claim 3, wherein a concentrate is produced in step (b) having a dry matter content of about 65 to about 90% by weight.

9. The process of claim 3, wherein the caramelization in step (c) is carried out at a temperature in the range of about 85 to about 95° C.

10. The process of claim 3, wherein the first cooling and second cooling (steps d and f) are carried out at temperatures in the range of about 30 to about 40° C., and about 20 to about 25° C., respectively.

11. The process of claim 3, wherein the vacuum-belt drying is carried out at temperatures in the heating zones in the range of about 60 to about 90° C. and pressures of about 0.1 to about 0.9 bar.

12. The process of claim 3, wherein the cooled product of step (f) is applied using a feed pump and an oscillating nozzle as foam to the conveyor belts of the vacuum-belt dryer.

13-15. (canceled)

16. A milk drink containing the milk powder of claim 1.

17. A chocolate product containing the milk powder of claim 1.
